(19) United States
(12) Patent Application Publication
(10) Pub. No.: US 2013/0046741 A1
(43) Pub. Date: Feb. 21, 2013

(54) METHODS AND SYSTEMS FOR CREATING AND SAVING MULTIPLE VERSIONS OF A COMPUTER FILE

(71) Applicants: Gregory Bentley, Sahuarita, AZ (US); Lisa Marie Cottrell, Sahuarita, AZ (US)

(72) Inventors: Gregory Bentley, Sahuarita, AZ (US); Lisa Marie Cottrell, Sahuarita, AZ (US)

(21) Appl. No.: 13/660,051

(22) Filed: Oct. 25, 2012

Related U.S. Application Data
(63) Continuation-in-part of application No. 12/378,340, filed on Feb. 13, 2009, now abandoned.
(60) Provisional application No. 61/065,568, filed on Feb. 13, 2008.

(51) Int. Cl. G06F 17/30

(52) U.S. Cl. 707/695; 707/E17.014

(57) ABSTRACT

Methods and systems for creating and saving multiple versions of a computer file in a computing environment, such as within a central processing unit, are disclosed. The systems generally include a central processing unit that is configured to (a) detect a change imparted to a first version of a computer file by a first program, (b) save a second version of the computer file, which incorporates the change imparted by the first program, (c) detect a change imparted to the first version of the computer file by a second program, and (d) save a third version of the computer file, which incorporates the change imparted by the second program.

### CROSS-REFERENCE TO RELATED APPLICATIONS

This application is a continuation-in-part of application Ser. No. 12/378,340, filed on Feb. 13, 2009, which claims priority to provisional application Ser. No. 61/065,568, filed on Feb. 13, 2008.

### FIELD OF THE INVENTION

The field of the present invention relates to the field of computing, computer software, and methods embodied in and transforming parts of a central processing unit of a computer. More particularly, the present invention generally relates to methods and systems for creating and saving multiple versions of a computer file, within a central processing unit of a computer.

### BACKGROUND OF THE INVENTION

The use of computer software and hardware to create, save, and maintain multiple versions of a computer file are well-known, and have been used for several years. For example, so-called versioning software programs and related systems are generally capable of saving multiple versions of a computer file, either automatically or in response to an instruction from a user. The different versions of a computer file may be created by one or more computer programs that have imparted a change to a particular computer file.

In the prior art versioning software programs and related systems, when a first program imparts a change to a computer file, the versioning software may create a second version of the file which incorporates the change, and archive and save the prior unedited version. If a second program accesses the second version of the computer file and imparts a change thereto, the versioning software may create a third version of the file which incorporates the change, and archives and saves the prior second version. Accordingly, the prior art versioning programs will create and save new versions of a computer file, whether each version was created by the same or a different computer program. This design has several drawbacks, including the ability of a first program to impart unwanted (or inadvertent) changes to a computer file being created and/or edited by a second program. In some cases, the first program may constitute, for example, a computer virus, adware, or spyware. Of course, it would be desirable to employ versioning software that is capable of limiting and/or confining the damage and changes to a computer file that such malware may impart—or otherwise limiting the ability of a second program to impart an unwanted modification to a computer file that has been created by another first computer program. The prior art versioning software programs are deficient in such ability.

Accordingly, a need exists for improved methods and systems for creating and saving multiple versions of a computer file. As the following will describe, such improved methods and systems are provided by the present invention.

### SUMMARY OF THE INVENTION

The present invention generally relates to methods and systems for creating and saving multiple versions of a computer file in a computing environment, such as within a central processing unit. According to certain embodiments of the present invention, the systems and methods generally comprise a central processing unit (of a computing device) that is configured to (a) detect a change imparted to a first version of a computer file by a first program, (b) save a second version of the computer file, which incorporates the change imparted by the first program, (c) detect a change imparted to the first version of the computer file by a second program, and (d) save a third version of the computer file, which incorporates the change imparted by the second program. As used herein, the term “central processing unit,” sometimes abbreviated as “CPU,” refers generally to an electronic circuit that is capable of executing computer programs, which may be embodied in a computer processor, microprocessor, server, and other devices, and will be capable of communicating with, saving, extracting, and modifying computer files which are recorded within a computer readable and recordable media. According to certain embodiments, as discussed herein, the first program is prohibited from accessing and modifying the third version of the computer file within the central processing unit and, likewise, the second program is prohibited from accessing and modifying the second version of the computer file.

According to additional embodiments of the present invention, computing devices are provided that incorporate one or more software programs that are capable of performing the methods described herein.

The above-mentioned and additional features of the present invention are further illustrated in the Detailed Description contained herein.

### BRIEF DESCRIPTION OF THE FIGURES

FIG. 1 is a flow diagram representing certain exemplary systems and methods of the present invention, involving the creation and maintenance of two lineages of computer files using two separate programs.

FIG. 2 is a flow diagram representing certain additional systems and methods of the present invention, involving the creation and maintenance of three lineages of computer files using three separate programs.

FIG. 3 is a flow diagram representing certain exemplary systems and methods of the present invention, involving the creation and maintenance of an additional version of a computer file using a computer program, based on a previous version created by another computer program that is associated with a different lineage of computer file versions.

FIG. 4 is another flow diagram representing certain exemplary systems and methods of the present invention, involving the creation and maintenance of an additional version of a computer file using a computer program, based on a previous version created by another computer program that is associated with a different lineage of computer file versions.

FIG. 5 is a flow diagram that illustrates the access rights that a particular program may have to certain previous versions of a computer file, within separate lineages, which were created by other computer programs.

FIG. 6 is another flow diagram that illustrates the access rights that a particular program may have to certain previous versions of a computer file, within separate lineages, which were created by other computer programs.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

The present invention generally relates to certain methods and systems for creating and saving multiple versions of a computer file within a computing environment, such as a computing device (e.g., a personal computer, server, mainframe, mobile computing device, smart phone, kiosk, and others). According to certain embodiments, the methods and systems of the present invention are capable of detecting, associating, and recording each change that is written to a computer file (and the computer program responsible for imparting such change) within a central processing unit. According to certain embodiments, the methods and systems of the present invention further create a new (or second) version of the computer file, while also maintaining a copy of the previous unedited version of the computer file. When the program that imparted such change later accesses the computer file from the central processing unit, the program presents, within a user interface of a computing device, the version of the computer file which it most recently saved. An important aspect of the present invention is that the central processing unit may be instructed (programmed) such that the computer program will not receive and, in certain embodiments, is unable to access the changes made to the computer file by other programs. Accordingly, the invention provides that multiple branches (or lineages) of a computer file are created and maintained within the central processing unit, which represent a lineage of versions (or branches of different versions) that are correlated to each computer program which modified the computer file. The prior art versioning software programs are not capable of monitoring and maintaining this type of computer program and computer file versioning association.

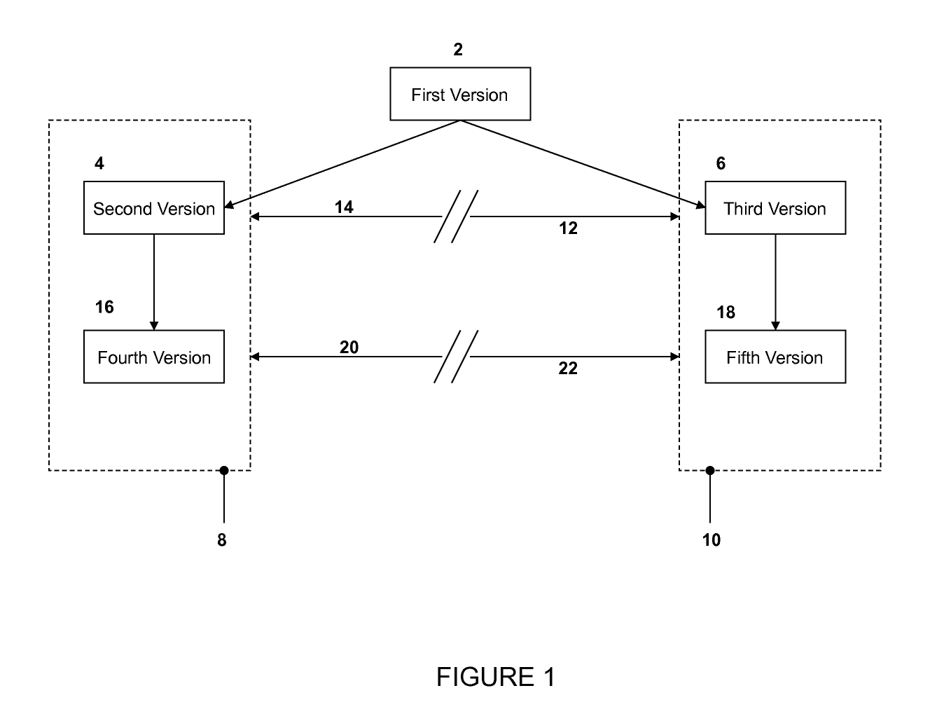

Referring now to FIG. 1, in certain embodiments of the present invention, methods and systems for saving multiple versions of a computer file are provided. The systems generally comprise a central processing unit that is configured to detect a change imparted to a first version 2 of a computer file by a first program 8, and to save a second version 4 of the computer file, which incorporates the change imparted by the first program 8. The central processing unit is further configured to detect a change imparted to the first version 2 of the computer file by a second program 10, and to save a third version 6 of the computer file, which incorporates the change imparted by the second program 10. In certain embodiments, the invention provides that the central processing unit is provided with instructions, which prevent the second program 10 from accessing and imparting a change 14 to the second version 4 of the computer file—or any other version of the computer file generated by the first computer program 8. Similarly, according to certain embodiments of the present invention, the central processing unit is provided with instructions, which prevents the first program 8 from accessing and imparting a change 12 to the third version 6 of the computer file—or any other version of the computer file generated by the second computer program 10.

The methods and systems described herein further comprise generating and maintaining a record, which is housed within some form of recordable media (e.g., a computer hard drive, an internal memory card, a server, portable media such as a DVD disc, etc.), which may or may not reside within the central processing unit, which indicates that the first program 8 imparted the change to the first version 2 of the computer file to create the second version 4 of the computer file. Similarly, the systems described herein further comprise a central processing unit that is configured to generate and maintain a record, which is housed within some form of recordable media, which indicates that the second program 10 imparted the change to the first version 2 of the computer file to create the third version 6 of the computer file.

The invention provides that after the second version 4 of the computer file is created, upon accessing the computer file with the first program 8, only the second version 4 of the computer file is presented. Likewise, after the third version 6 of the computer file is created, upon accessing the computer file with the second program 10, only the third version 6 of the computer file is presented.

Still referring to FIG. 1, upon the central processing unit being instructed to access the second version 4 of the computer file with the first program 8, and imparting a second change to the second version 4 of the computer file using the first program 8, the central processing unit will be configured to create and save a fourth version 16 of the computer file (which incorporates the second change imparted by the first program 8), which will be maintained by the central processing unit. Still further, upon the central processing unit being instructed to access the third version 6 of the computer file with the second program 10, and imparting a second change to the third version 6 of the computer file, a fifth version 18 of the computer file is created, saved and maintained by the central processing unit. As described above, in certain embodiments of the invention, the first program 8 may only access and modify the first version 2, second version 4, and fourth version 16 of the computer file. Likewise, according to such embodiments, the second program 10 may only access and modify the first version 2, third version 6, and fifth version 18 of the computer file. In other words, the first program 8 may not access and modify 22 the third version 6 or fifth version 18 of the computer file, whereas the second program 10 may not access and modify 20 the second version 4 or fourth version 16 of the computer file.

While the present specification makes reference to a first and second program creating first, second, third, and additional versions of a computer file, it should be appreciated that such nomenclature is used to signify the ability of the methods and systems described herein to maintain a separate lineage of computer file versions created by a plurality of different computer programs. It should be appreciated that the various computer file versions may be created according to any chronology or sequence. For example, it is possible for the central processing unit to instruct the first computer program to generate computer file versions two and three, which is followed in time by the second computer program being instructed to generate computer file versions four and five. Alternatively, the generation of computer file versions may occur in a different order, such as that shown in FIG. 1, in which a first computer program 8 creates a second version 4, which is followed in time by a second computer program 10 creating a third version 6, and so on.

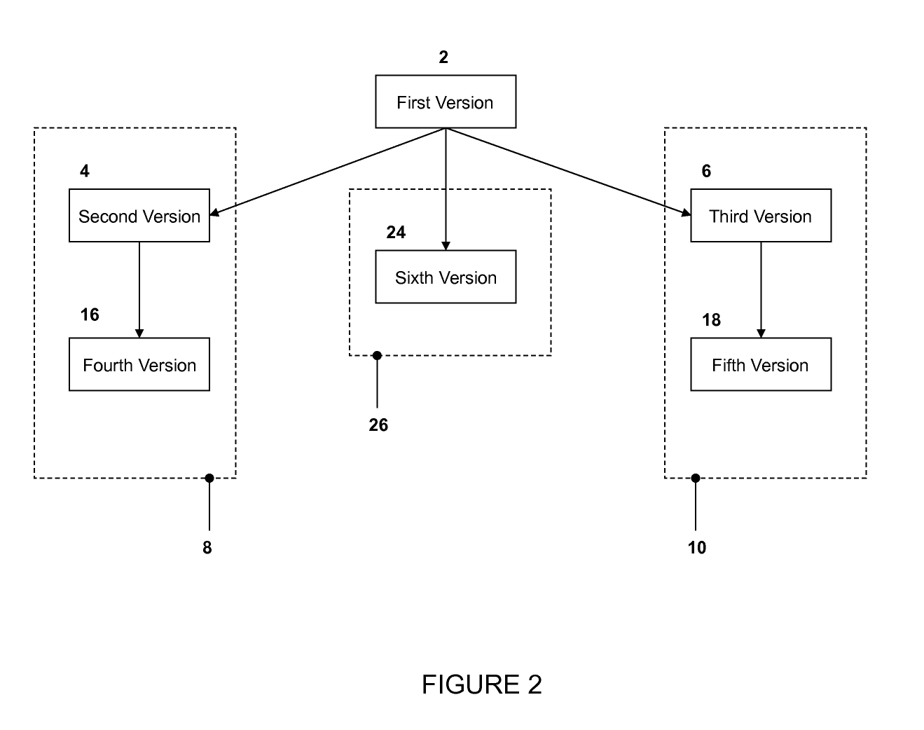

The methods and systems of the present invention are capable of maintaining separate lineages of computer file versions (each of which being associated with a single computer program), for a plurality of computer programs. For example, referring to FIG. 2, upon instructing the central processing unit to cause a third program 26 to access the first version 2 of the computer file and impart a change thereto, a sixth version 24 of the computer file is created and saved by the central processing unit.

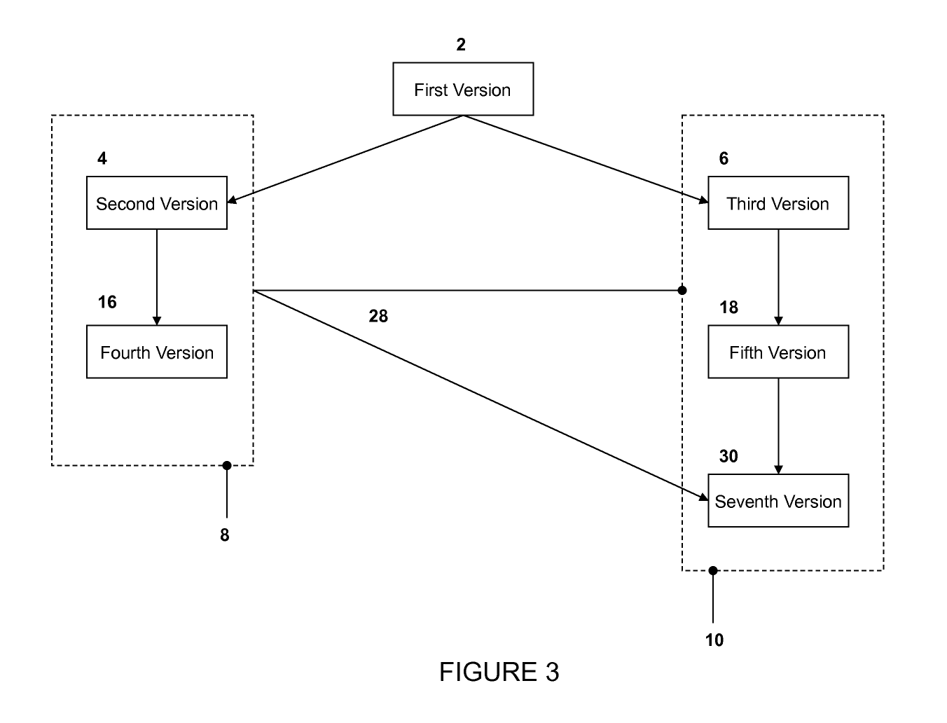

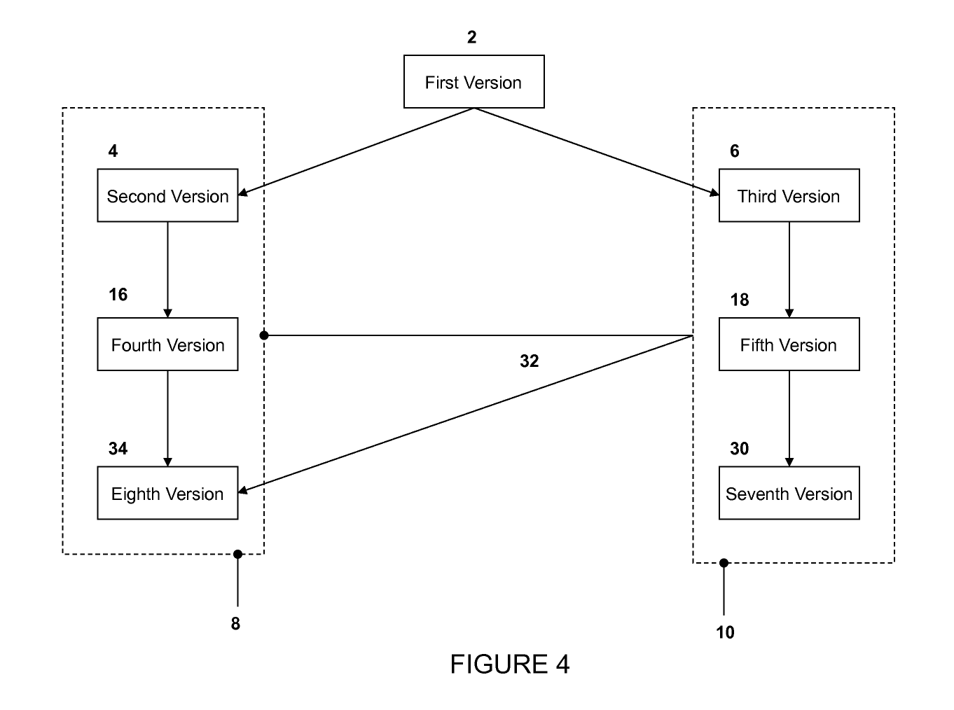

According to still further embodiments of the invention, the central processing unit may be configured to instruct a computer program to access and modify a computer file version from a lineage of versions created by a different computer program, provided that the resulting new version is added to the version lineage of the computer program that is imparting the modification. For example, referring to FIG. 3, the central processing unit may instruct the second computer program 10 to access and modify 28 the second version 4 or fourth version 16 of the computer file, provided that upon the creation of a resulting seventh version 30 of the computer file, the seventh version 30 is associated with the lineage of computer file versions for the second computer program 10. Similarly, referring to FIG. 4, the central processing unit may instruct the first computer program 8 to access and modify 32 the third version 6, fifth version 18, or seventh version 30 of the computer file, provided that upon the creation of a resulting eighth version 34 of the computer file, the eighth version 34 is associated with the lineage of computer file versions for the first computer program 8. This ability to request and impart changes to a computer file version maintained within another lineage allows a user to intentionally use multiple programs (e.g., multiple image editing tools) on a computer file, while still preventing malicious or accidental changes to files.

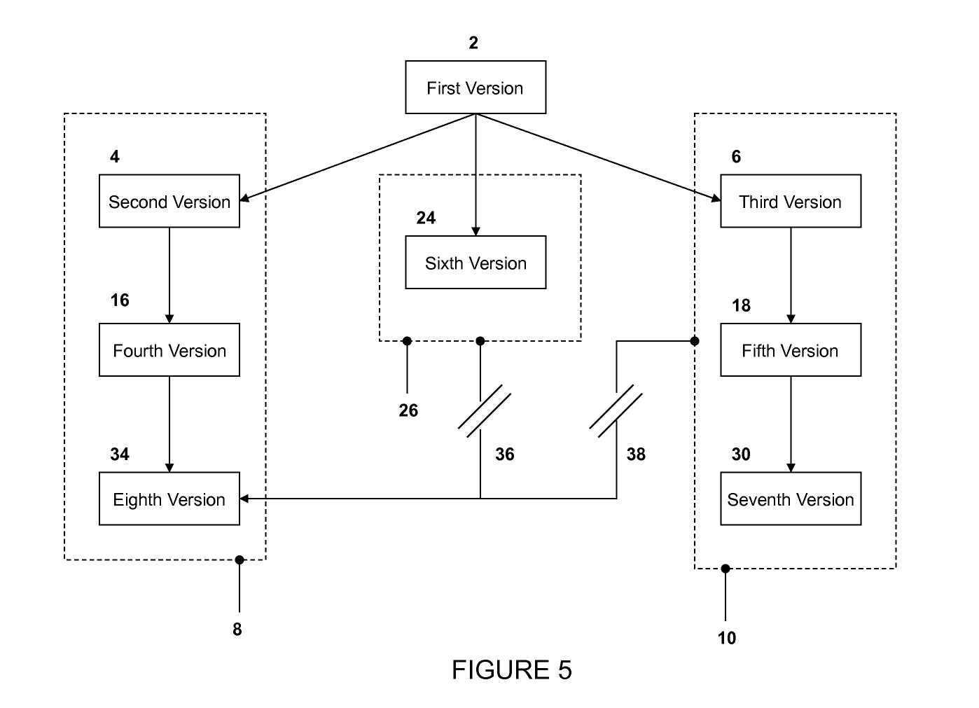

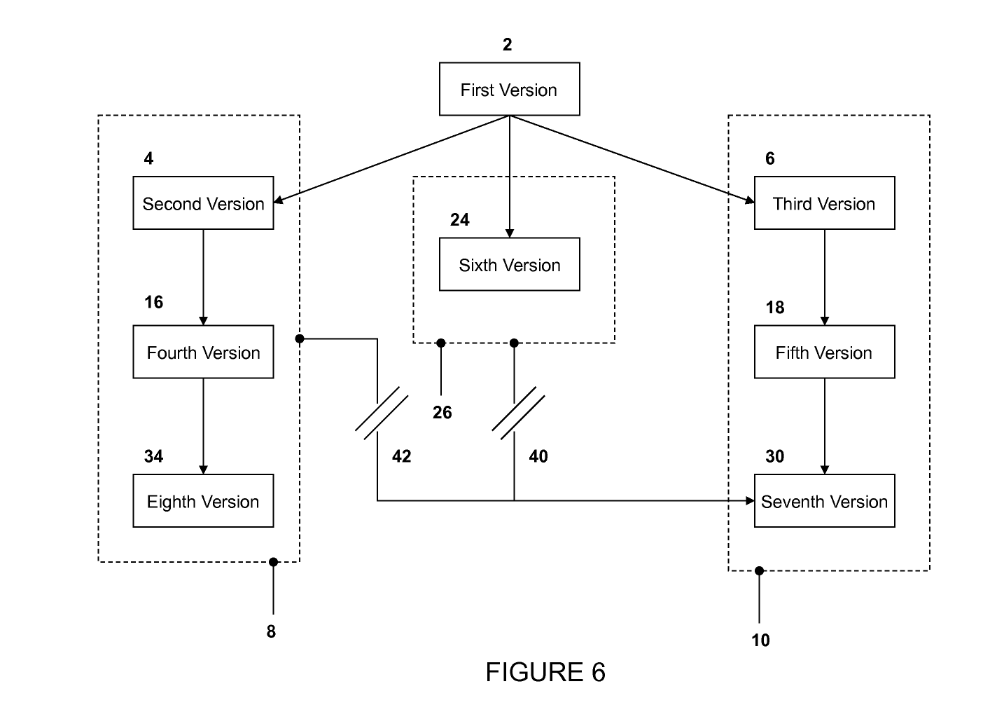

According to these embodiments, the ability of a computer program to access and modify computer files within a version lineage that is associated with other computer programs may be selectively enabled or disabled. For example, just as the first program 8 is shown to be capable of accessing and modifying 32 the computer file versions within the lineage associated with the second computer program 10 in FIG. 4 (provided that the resulting new eighth version 34 is associated with the first program 8), the central processing unit may be instructed to disable such functionality. For example, referring to FIG. 5, when such functionality is disabled by the central processing unit, the second program 10 and third program 26 may not access 38,36 the eighth version 34 of the computer file, whereas only the first program 8 may access and modify the eighth version 34 of the computer file. Likewise, referring to FIG. 6, the first program 8 and third program 26 may not access and modify 42,40 the seventh version 30 of the computer file, whereas only the second program 10 may access and modify the seventh version 30 of the computer file.

The computer file version maintenance systems described herein will continue to use available storage space until the storage device (recordable media) is filled, or otherwise reaches a predefined threshold (such as 70%, 80%, 90%, etc. filled). As such, a user (and the central processing unit) will be able to utilize every byte of system storage space to hold data of potential value, rather than leaving the device filled with meaningless random bits. When the storage device is full (or otherwise reaches a predefined threshold) and more space is needed, the central processing unit may be instructed to delete the least recently used computer file within the storage device (media)—to make room for new files. Such file storage maintenance practices may be carried out, for example, by instructing the central processing unit to rank a plurality of computer file versions based on the number of times that each version has been accessed within a defined period of time. Once the computer files have been ranked, one more versions of the computer file (which have not been accessed a certain minimum number of times within the defined period of time) may be subsequently deleted. Still further, the invention provides that a user may instruct the central processing unit to display such ranking within a user interface of a computing device, thereby allowing the user to view those files which have been, or will be at some point in the future, deleted from the recordable media.

According to these embodiments, the invention provides that, preferably, only backup versions of the computer files are eligible for deletion. The newest (or most recently-created) versions are not. In this way, the file system only replaces data which would not exist on conventional file archival systems. The user will not lose any data that would otherwise exist in a traditional, single-version file system. Still further, the invention provides that individual files that are of particular concern to a user may also be designated by the central processing unit as ineligible for replacement or deletion, such that these files will not be automatically deleted (regardless of its placement within a lineage of files or the number of times that it has been accessed within a defined period of time). Such feature allows a user to indefinitely maintain a copy of every version of a designated computer file that is of particular interest or value.

The multiple computer file versions created by the methods and systems described herein may be stored internally as, for example, multiple full copies, a single file and a list of differences, multiple computer file copies with portions (or sectors) shared between file versions for areas of the file which are unchanged, or any combination of the foregoing. These various mechanisms allow for a range of space saving and speed-optimizing tradeoffs.

According to additional embodiments of the present invention, computing devices are provided that incorporate the centralized processing unit described herein, and one or more software programs that are capable of performing the methods described herein. Such computing devices may include personal computers of all kinds, portable electronic devices (such as PDAs, cellular telephones, smart phones, and the like), servers, mainframes, and any other computing device. The invention further provides that the computing device may be manufactured with the software installed shortly thereafter, and prior to being received by an end user. Alternatively, the invention provides that the software may be provided to an end user via portable media, and subsequently installed into a computing device. Still further, the invention provides that the software which may be used in connection with the methods described herein may be downloaded over the internet and into a target computing device.

The invention provides that maintaining multiple lineages of computer file versions provides a number of benefits. For example, the methods and systems of the present invention make it possible to access previous versions of a computer file. If a user desires to revert a recent change that was imparted to a computer file (or accidentally saves an unwanted change or inadvertently deletes a computer file), the user may revert to a previous version of the same computer file.

Moreover, according to certain embodiments of the invention, a computer program may not access a version created by another computer program, such that a computer program is prevented from imparting unwanted or inadvertent changes to a computer file version that was created by another computer program. Such design has many benefits. For example, non-limiting examples of such unwanted changes include the spreading of computer viruses, adware, and spyware. In addition, since an operating system program loader is considered to be yet another program, it will also have its own branch (or lineage) of computer files which it accesses, reads, and modifies.

Accordingly, the present invention provides that any malware that modifies, for example, an executable program will receive its own independent version of the subject computer file. As such, the operating system program loader will access and utilize its own version of the executable file, rather than the infected version. Likewise, any malware that attempts to access and infect startup scripts, configuration files, plugins, and the like, will not be able to affect the computer file version which will actually be used. Accordingly, the methods and systems of the present invention supplants the need to employ anti-virus software—to detect a malware (e.g., computer virus infection) after the fact. When the methods and systems of the present invention are employed, infected files are harmless, and computer programs which attempt to write to executable files can be easily detected.

Furthermore, the methods and systems of the present invention protect a user from inadvertently damaging an operating system or application programs. For example, even if the user deletes key configuration files, the user will actually only be deleting the version of the computer file modified or accessed by the user's command shell or GUI. The version of the file which is actually used by the operating system (or application program) will remain unaffected.

An additional benefit of the methods and systems described herein is the ability to search for data and computer file versions within a single lineage of files (i.e., within a lineage of computer files created by a single computer program). For example, when a user opens the file dialog box for a computer program, the user may be presented with only the computer files which were authored by the applicable computer program. Since the system will have a record of which computer files were authored by each computer program, the user can be presented with all the relevant computer files from the entire disk, while excluding the unrelated computer files and directories. Thus, the invention provides that rather than the user being forced to remember or search for the location of a particular computer file, the application itself may use the data stored by the system described herein to automatically present the appropriate information and computer file lineage.

According to certain additional embodiments, the invention provides that the systems will be configured to maintain a record of the programs that author, edit, and read each file (and when each such program authors, edits, and reads each file). As such, a user will be able to identify the files that are being used by a particular program and, conversely, monitor which programs are requesting and using a particular file. Such information can be used for a variety of purposes, including, for example, identifying the source of a computer virus (e.g., determining the program that last modified and corrupted a particular file), identifying unused files that can be archived or deleted, and optimizing future uses of particular files. In addition, this embodiment allows a user to identify the files that are frequently being used by a particular program. The invention provides that whether or not a program's use of a particular file is deemed frequent may be objectively monitored and determined, e.g., by setting a certain minimum threshold for the amount of times that a program must request a file, within a defined period of time, to be considered a frequent user of a particular file.

More particularly, this embodiment of the present invention allows users to identify particular files that are closely associated with a certain program (i.e., frequently opened, closed, read, or edited by a program), such that the file (and its location) can be optimized in any of various ways. For example, this feature of the system may be used to load a particular file into a random access memory (RAM) cache as soon as a program is launched (when such program is identified as a frequent user and editor of such file), such that the file will already be available when it is requested by the program (instead of waiting to load the file when the program actually requests access to such file). Similarly, the invention provides that a particular file may be cached onto a higher speed device, such as a solid state drive (SSD) or secure digital (SD) card, as soon as the associated program is launched (when such program is identified as a frequent user and editor of such file). This way, as explained above, the amount of time required to request and access such file will be reduced.

The invention further provides that the ability to identify particular files that are closely associated with a certain program (i.e., frequently opened, closed, read, or edited by a program) allows the system to re-organize the files located on a physical disk, such that a particular program (and the files that are frequently used by such program) are located contiguously on the disk. The invention provides that such re-organization function will allow all relevant files and data to be quickly accessed by the associated program, without requiring the program to unnecessarily search unrelated areas of a disk. Importantly, currently-available disk defragmenters are only concerned with contiguously recording and positioning individual files and, unlike the system of the present invention, such currently-available disk defragmenters do not attempt to also position other associated files (e.g., multiple versions of the same file) in close proximity to each other (and in close proximity to the programs that request and use such files).

The invention provides that the ability to optimize the location of certain files on a disk may be performed with even finer granularity. For example, if one portion of a file is commonly used by a first program, while another portion of the same file is commonly used by a second (different) program, the system of the present invention can record and position each of such portions in close proximity to the respective programs (which frequently request, use, and/or edit each such file).

In addition to monitoring and controlling the ability of a program to access, read, and modify (edit or write to) a particular file, the invention provides that other behaviors may be, optionally, carried out by the system of the present invention. For example, if a program requests access to a particular file, and the system determines that such program was not the original author/creator of the file, the system can be instructed to communicate a “system error” to the program, indicating that the requested file does not exist or that the user is not authorized to access such file. Alternatively, if a program requests access to a particular file, and the system determines that such program was not the original author/creator of the file, the system can be instructed to communicate a message to the program, which indicates that the file has been successfully opened, but that subsequent reads will (i) indicate that the file is empty (i.e., zero bytes long) or (ii) return a “dummy” file comprised of innocuous data. In this embodiment, for example, an address book might return a single fictitious entry rather than the real contact information contained in the main copy of the file. According to yet further embodiments, if a program requests access to a particular file, and the system determines that such program was not the original author/creator of the file, the system can be instructed to ask the user (e.g., via a pop-up window or other user interface) whether full read access should be granted for the requested file, or if any of the above-described alternative behaviors should be applied. The above-described alternative behaviors can be advantageous in preventing malware attacks on files, when (a) such attacks are launched through a program that is voluntarily and legitimately installed (rather than through some exploitation of a security hole in the system) and (b) such program nonetheless is armed with additional malicious code and functionality (in addition to its legitimate and advertised functionality), e.g., an operable and seemingly innocent video game that a user installs, which is configured to secretly read and distribute sensitive information from a user's disk (such as contact information, financial information, etc.).

While there have been shown and described fundamental features of the invention as applied to preferred embodiments thereof, it will be understood that various omissions and substitutions and changes in the form and details of the methods and systems illustrated and/or described herein, and in their operation, may be made by those of ordinary skill in the art without departing from the spirit of the invention. For example, it is expressly intended that all combinations of those elements and/or method steps which perform substantially the same function in substantially the same way to achieve the same results are within the scope of the invention.

What is claimed is:

1. A system for saving multiple versions of a computer file, which comprises a central processing unit, which is configured to:
(a) detect a change imparted to a first version of a computer file by a first program;
(b) save a second version of the computer file, which incorporates the change imparted by the first program;
(c) detect a change imparted to the first version of the computer file by a second program; and
(d) save a third version of the computer file, which incorporates the change imparted by the second program, wherein (i) if the first program subsequently imparts a change to the second version of the computer file, the central processing unit will save a fourth version of the computer file and (ii) if the second program subsequently imparts a change to the third version of the computer file, the central processing unit will save a fifth version of the computer file, wherein the central processing unit is further configured to:
(x) identify computer files that are opened by the first program a certain minimum number of times within a defined period of time and load such computer files into a random access memory cache, solid state drive, or secure digital card upon launching the first program; and
(y) identify computer files that are opened by the second program a certain minimum number of times within a defined period of time and load such computer files into a random access memory cache, solid state drive, or secure digital card upon launching the second program.

2. The system of claim 1, wherein the central processing unit is further configured to prevent the second program from accessing and imparting a change to the second version of the computer file.

3. The system of claim 2, wherein the central processing unit is further configured to prevent the first program from accessing and imparting a change to the third version of the computer file.

4. The system of claim 3, wherein the central processing unit is further configured to create a record that indicates that the first program imparted the change to the first version of the computer file to create the second version of the computer file.

5. The system of claim 4, wherein the central processing unit is further configured to create a record that indicates that the second program imparted the change to the first version of the computer file to create the third version of the computer file.

6. The system of claim 5, wherein after the third version of the computer file is created, upon the central processing unit accessing the computer file with the second program, only the third version of the computer file is presented in the user interface of a computing device.

7. The system of claim 6, wherein the central processing unit is further configured to allow the first program to access the first version, second version, and fourth version of the computer file, and deny access to the third version and fifth version of the computer file by the first program.

8. The system of claim 7, wherein the central processing unit is further configured to allow the second program to access the first version, third version, and fifth version of the computer file, and deny access to the second version and fourth version of the computer file by the second program.

9. The system of claim 8, wherein the central processing unit is further configured to create and save a sixth version of the computer file upon a third program accessing the first version of the computer file and imparting a change thereto.

10. The system of claim 9, wherein the central processing unit is further configured to (i) rank a plurality of versions of the computer file based on a number of times each version is accessed within a defined period of time and (ii) delete one or more versions of the computer file which have not been accessed a certain minimum number of times within the defined period of time.

11. The system of claim 10, wherein the central processing unit is further configured to display a ranking of the plurality of versions of the computer file based on a number of times each version is accessed within a defined period of time within the user interface of the computing device.

12. A system for saving multiple versions of a computer file, which comprises a central processing unit, which is configured to:
(a) detect a change imparted to a first version of a computer file by a first program;
(b) save a second version of the computer file, which incorporates the change imparted by the first program;
(c) detect a change imparted to the first version of the computer file by a second program; and
(d) save a third version of the computer file, which incorporates the change imparted by the second program, wherein (i) if the first program subsequently imparts a change to the second version of the computer file, the central processing unit will save a fourth version of the computer file and (ii) if the second program subsequently imparts a change to the third version of the computer file, the central processing unit will save a fifth version of the computer file, wherein the central processing unit is further configured to:
(x) identify computer files that are opened by the first program a certain minimum number of times within a defined period of time and load such computer files into a random access memory cache, solid state drive, or secure digital card upon launching the first program;
(y) identify computer files that are opened by the second program a certain minimum number of times within a defined period of time and load such computer files into a random access memory cache, solid state drive, or secure digital card upon launching the second program; and
(z) record contiguously to a disk the first program and all versions of the computer files that are opened by the first program a certain minimum number of times within a defined period of time; and record contiguously to a disk the second program and all versions of the computer files that are opened by the second program a certain minimum number of times within a defined period of time.

13. The system of claim 12, wherein the central processing unit is further configured to record contiguously to a disk the first program and all versions of the computer files, or limited portions of such versions of the computer files, which are opened by the first program a certain minimum number of times within a defined period of time.

14. The system of claim 12, wherein the central processing unit is further configured to record contiguously to a disk the second program and all versions of the computer files, or limited portions of such versions of the computer files, which are opened by the second program a certain minimum number of times within a defined period of time.
